(19) United States
(12) Patent Application Publication
(10) Pub. No.: US 2013/0018537 A1
(43) Pub. Date: Jan. 17, 2013

(54) Central Vehicle data and control system or artificial intelligence driver assistance device

(71) Applicant: Eliahu Arad, Tel Aviv (IL)

(72) Inventor: Eliahu Arad, Tel Aviv (IL)

(21) Appl. No.: 13/135,782

(22) Filed: Jul. 15, 2011

(51) Int. Cl. G06F 17/00

(52) U.S. Cl. 701/22; 701/36

(57) ABSTRACT

A system designed for electric vehicles that comprises a processor, a memory component, an accelerometer, a loudspeaker, and a power source and that is connected to the vehicle's systems by means of a CAN-bus cable and which processes, produces and synthesizes the information to create a sound that is emitted from the loudspeaker and which corresponds to the status of the motor and/or the velocity and/or acceleration of the vehicle.

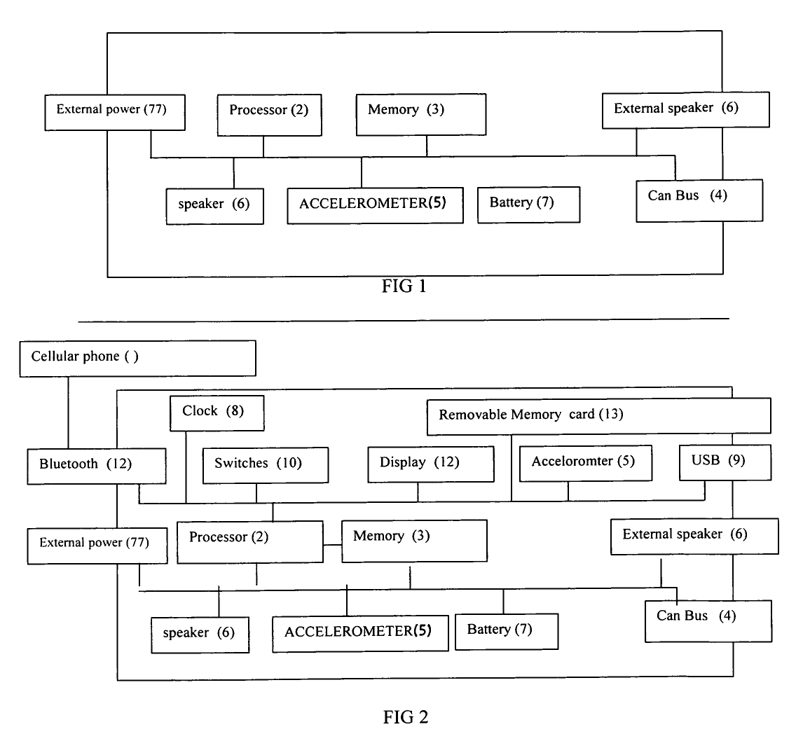

### TECHNICAL FIELD

The present invention refers to an electronic system designed, among other things, to produce sounds that correspond to the motor action and/or velocity of electric vehicles and/or silent vehicles as well as motorless means of transport.

### BACKGROUND ART

Some vehicles have electric motors that do not produce typical noises when they run, as do vehicles with regular (fuel-propelled) engines. It is known that the average pedestrian customarily exercises caution with respect to vehicles traveling in his or her vicinity thanks, among other things, to the noise produced by the vehicle. Specifically, the noise produced by the vehicle's engine serves to warn pedestrians of its actual presence in the close vicinity and acts as an indicator of its velocity and acceleration. This is true also for the average driver of a standard (fuel-propelled) vehicle, who is accustomed to operating his or her vehicle according to the noises produced by its engine, which serve as indicators of velocity, acceleration, and so on. Electric vehicles do not produce these noises, and thus can constitute a danger to pedestrians and even to the driver, who may misinterpret the vehicle's status in terms of velocity, acceleration, motor rpm, and so on. The system, subject of the present invention, provides an appropriate solution to the above-described problem and offers the user additional advantages and possibilities. Some versions of the system can also be used on motorless means of transport such as bicycles.

### THE INVENTION

The first embodiment of the present invention refers to a system (1) that includes a processor (2), a memory component (3), a CAN-bus connection cable (4) between the system (1) and the vehicle's systems, an accelerometer (5), and a loudspeaker (6). The system is depicted schematically in Drawing No. 1.

The processor (2) executes the operations and commands it receives from the memory component (3) that contains the software that runs the system (1). A processor such as BC5 MM EXT BC57E687C-GITB-E4 made by CSR may successfully fulfill the role of the processor (2). Any one of a variety of standard memory components can be used as the memory component (3).

The system is connected to the vehicle's systems by means of a CAN-bus connection cable (4) through which it receives relevant information from them and from the accelerometer (5). The system (1) also uses the software installed on it to relay commands to the vehicle's systems and to the components of the system (1) itself.

A CAN-bus connector cable (4) connects the system (1) the vehicle's central computer (the motor's computer) from which it receives information about the vehicle's velocity, motor rpm, as well as additional information from other vehicle systems that are connected via the CAN-bus cable (4). Using its internal components, the system (1) processes these data and produces a sound that corresponds to the status of the motor action and/or the vehicle's velocity and/or acceleration. In other words, the system synthesizes the information using the to software and creates a sound that is emitted from the loudspeaker. The sound produced by the system (1) changes according to changes in the motor's action, just like noise produced from a regular engine under similar conditions of operation, and serves to alert the driver and/or pedestrians.

The system (1) includes a loudspeaker (6) that emits the sounds in accordance with the motor's status of operation. The system (1) can include an internal loudspeaker that emits sounds as mentioned into the driver's compartment or an external loudspeaker that is installed under the hood (or elsewhere in the vehicle) and emits sounds to the vehicle's external environment.

Nevertheless, the inventor believes that the system (1) should include two loudspeakers (6): one in the driver's compartment for the benefit of the driver and passengers, and the other under the hood (or elsewhere in the vehicle) that emits sounds to the external environment of the vehicle. The sounds that are produced can resemble noises made by a fuel-propelled engine or other sounds. The memory component (3) is equipped with software designed to translate the signals and information received from the vehicle's computers into sounds that are produced by the system (1) and emitted from the loudspeaker (6).

The system (1) includes an internal power source (7) or a connection (77) to an external power source (direct connection to the vehicle's battery or charging system).

The second embodiment of the present invention refers to a system (1) that includes all of the components described in the first embodiment, as well as a timer (8), a USB cable (9) [or any other connection currently available and/or that will be available in the future and is hereinafter referred to as the USB cable], activation buttons (10), a display panel (11), a Bluetooth-type connection (12) [that is capable of transmitting signals to a cell phone within a 100 meter radius], a removable memory component (13) [anywhere the term “memory component” is used, the meaning includes also a “removable memory component”], a connection to a cell phone (14), a device (microphone) for receiving voice commands from the driver (15) [enables the driver to operate the system using his or her voice rather than the buttons]. The system is depicted schematically in Drawing No. 2.

The second embodiment of the system (1) is designed to collect information from the vehicle's systems and to perform additional operations to those performed under the first embodiment of the invention.

The system (1) is connected by means of a CAN-bus cable to a variety of the vehicle's systems, such as the (a) vehicle's central computer (the motor's computer); (b) gas pedal system (the system that corresponds to the fuel throttle in a fuel-propelled vehicle); (c) braking system's computer; (d) vehicle's cameras; (e) distance sensors (e.g. reverse travel sensors); (f) door position sensors (open/closed); (g) charging status of the batteries (as the vehicle has an electric motor); and so on.

The system (1) is connected, as mentioned, to a variety of the vehicle's computer systems and other devices from which it receives a great deal of information, such as: velocity, acceleration (from the accelerometer which constitutes part of the system itself), fuel consumption rate, motor rpm, vehicle's travel times, repetitiveness in the vehicle's operations (such as in travel times and distances), and so on. The second embodiment of the system (1) emits sounds according to the vehicle's status of operation, as was described for the first embodiment of the system, and it is also enables the following operations:

The USB connection (9) and the Bluetooth connection (12) enable the user to install up-to-date programs on the memory component (3) and to charge an internal battery (7) (if such exists).

The system (1) also serves as a kind of black box for the vehicle: Data collected by the system (1), through the CAN-bus connection cable (4) and accelerometer (5), are stored in the memory component (3) and are documented according to the time of occurrence [using the timer (8), which constitutes part of the system itself]. Thus, it is possible to examine the operation of the vehicle in terms of travel velocity, travel times, and vehicle acceleration. It is noted that the accelerometer (5), which is part of the system (1), which measures the acceleration of the vehicle on three planes, and thus serves also as an indicator of “wild” or uneven driving. This information is important for post factum analysis of the vehicle's operation, for instance in case of an accident. The system (1) can also transmit these data to outside of the vehicle. Using the a cell phone connection or the Bluetooth 100 m connection

Vehicle velocity limit control: The software installed on the memory component (3) can give the vehicle commands that cancel or override commands to increase vehicle velocity given by the driver via the gas pedal if the vehicle reaches a certain velocity. This limit velocity can be defined in the software using the removable memory component (13) or via messages to the system (1) sent from a cell phone and it can be redefined by updating the system (1).

This Vehicle velocity limit control also imposed when car is doing too fast curve as detected by the 3 plans accelerometer in the system.

Real-time reporting of vehicle velocity and its operation: Whenever the vehicle reaches a certain velocity, as defined in the software, the software can transmit a report by means of the vehicle's cell phone to other telephones or call centers, as defined in the system. The velocity at which such a report is transmitted and the telephone number to which it is transmitted can both be changed by updating the system (1). The system (1) can also be programmed to report any wild driving done on the vehicle to call centers, as mentioned.

Transmission of messages to the driver: The system's software also includes the option of transmitting pre-recorded messages to the driver, such as a message informing the driver whenever he or she exceeds the maximum velocity that leads to the transmission of a message to another telephone as mentioned above (a kind of warning before the message is transmitted, whereby decreasing the velocity will cancel the transmission of the message); a message informing the driver of the charging status of the (electric) vehicle's batteries; a message transmitted to the driver's cell phone about the charging status of the batteries when the driver is outside of the vehicle, and so on. The system (1) includes the option of learning regular or repeated patterns of behavior with respect to the vehicle's use. For instance, the system (1) learns the times and days on which the vehicle is repeatedly used for extended travel and transmits an advance message about the charging status of the batteries to the driver's telephone (or to some other call center).

The system (1) depicted in the second embodiment of the invention can include all of the above described components and functions, although it is not mandatory, and systems (1) can be manufactured with all or part of the above-mentioned components and functions.

The third embodiment of the present invention refers to a system (1) designed for motorless means of transport, such as bicycles, skateboards and/or electric vehicles that do not support the use of CAN-bus cables, and so on. The system (1) in the third embodiment consists of a processor (2), a memory component (3), an accelerometer (5), a speedometer (17), a loudspeaker (6), and a power source (7). The system, which is contained in a casing that is attached to the relevant means of transport, produces relevant sounds according to changes in the velocity of the specific vehicle.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

### DESCRIPTION OF THE DRAWINGS

Drawing No. 1 presents a schematic description of the first embodiment of the system (1).

Drawing No. 2 presents a schematic description of the second embodiment of the system (1).

What is claimed is:

1. A system intended mainly for electric vehicles that consists of a processor, a memory component, a CAN-bus cable, an accelerometer, a loudspeaker, and an independent power source or connection to an external power source. The system is connected by means of the CAN-bus cable to the vehicle's systems and to the accelerometer, from which it receives relevant information. The system processes the said information (i.e. synthesizes it) and produces a sound that corresponds with the motor's operational status and/or to velocity and/or acceleration and is emitted from the loudspeaker.

2. The system mentioned in claim No. 1 whereby it also includes one or more of the following components: an internal timer, a USB connection, activation buttons, a display panel, a Bluetooth connection, a removable memory component, a connection to a cell phone, and a device (microphone) for receiving voice commands from the driver. The system is connected by means of the CAN-bus cable to the vehicle's systems, from which it receives relevant information and to which it transmits commands according to the software installed on the system. Thus, the system can also perform one or more of the following operations: Store data on the operation of the vehicle and document them according to time of occurrence; report the said data to a telephone or external call center; transmit commands to the vehicle's systems that cancel or override the driver's command to increase the vehicle's velocity; transmit real-time reports to a telephone or external call center about the vehicle's velocity and its operation; send the driver voice or other messages; transmit messages to a telephone or external call center about the charging status of the vehicle's batteries (even when not in use); learn regular behavior patterns with respect to operation of the vehicle.

3. A system designed for motorless means of transport and/or electric means of transport that do not support the use of CAN-bus cables, which consists of a processor, a memory component, an accelerometer, a speedometer, a loudspeaker, and a power source, whereby the system processes or synthesized the velocity and acceleration of the vehicle and produces a sound that corresponds with the motor's status of operation and/or the vehicle's velocity and/or acceleration and is emitted from the loudspeaker.
